(19) United States
(12) Patent Application Publication
(10) Pub. No.: US 2008/0187822 A1
(43) Pub. Date: Aug. 7, 2008

(54) Electrical Device, in Particular Electric Power Tool

(76) Inventor: Jan Breitenbach, Stuttgart (DE)

Correspondence Address: MICHAEL J. STRIKER, 103 EAST NECK ROAD, HUNTINGTON, NY, 11743, US

(21) Appl. No.: 11/911,921

(22) PCT Filed: Jul. 17, 2006
(86) PCT No.: PCT/EP2006/064315

§ 371 Date: Oct. 18, 2007

(30) Foreign Application Priority Data
Aug. 3, 2005 (DE) 102005036448.9

(51) Int. Cl. H01M 2/10

(52) U.S. Cl. 429/100

(57) ABSTRACT

The invention relates to an electric device, particularly an electric hand tool, comprising: a removable power supply unit (18, 50, 66, 114, 148, 182); an accommodating area (16) for accommodating the power supply unit (18, 50, 66, 114, 148, 182) inserted in a receiving direction (20) into the accommodating area (16); a guiding means (38, 52, 74, 116, 160, 184) for guiding the power supply unit (18, 50, 66, 114, 148, 182) in the accommodating area (16), and; a locking device (22, 58, 76, 126, 164, 186) for locking the power supply unit (18, 50, 66, 114, 148, 182) in the accommodating area (16). The invention provides that the locking device (22, 58, 76, 126, 164, 186) has a detent means (44, 46, 56, 78, 122, 124, 168, 188), which is formed by a shaping of the guiding means (38, 52, 74, 116, 160, 184).

### PRIOR ART

The invention is based on an electrical device, in particular an electric power tool, as generically defined by the preamble to claim 1.

From German Patent Disclosure DE 38 41 735 A1, an electrical device with a removable rechargeable battery is known. The electrical device is provided with two detent elements, which when the rechargeable battery is joined to a receptacle in the electrical device snap into recesses in the rechargeable battery, as a result of which the rechargeable battery is locked. For unlocking the rechargeable battery, the latter has two push buttons, and the detent elements release the rechargeable battery by means of pressing on the push buttons.

### ADVANTAGES OF THE INVENTION

The invention is based on an electrical device, in particular an electric power tool, having a removable power supply unit, a receiving region for receiving the power supply unit inserted in a receiving direction into the receiving region, a guide means for guiding the power supply unit in the receiving region, and a locking device for locking the power supply unit in the receiving region.

It is proposed that the locking device has a detent means, which is formed by a structured feature of the guide means. By means of an embodiment according to the invention, installation space intended for the guide means can advantageously be utilized for the locking device, making it possible to attain a compact design and easy assembly of the electrical device. The term “structured feature of the guide means” should be understood in this connection to mean an embodiment of the guide means intended for being snapped in, such as a recess in a bearing face embodied as a guide means, or a protruding portion of such a bearing face. The term “bearing face” should be understood in this connection to mean a face of the receiving region or of the power supply unit that in the locked state rests on a face of the power supply unit or of the receiving region.

Advantageously, the power supply unit has a housing, which has a side face that is embodied as a guide means. As a result, an especially space-saving embodiment of the guide means can be attained. To achieve effective guidance of the power supply unit, the side face, as the power supply unit is being inserted, can be oriented predominantly parallel to the receiving direction and embodied as a bearing face that in the locked state rests on a face of the receiving region. The term “side face”, in contrast to a top face and a bottom face, should be understood in particular to mean a lateral outer face of the power supply unit, with “lateral” referring to the receiving direction.

An especially compact embodiment of the locking device can be attained in that the guide means has at least one guide strip, with an interruption embodied as detent means. In addition, an orientation of the power supply unit as it is being inserted into the receiving region can be easily apparent to a user.

To attain a secure hold of the power supply unit, and in particular to prevent unwanted twisting of the power supply unit locked in the receiving region, the electrical device has a detent element, which in the locked state is snapped into structured features on both sides of the power supply unit.

Preferably, the detent element is retained by a cohesive actuating element, and as a result especially easy assembly and easy operation of the locking device can be attained.

Unintentional unlocking of the power supply unit can be prevented by providing that the electrical device is provided with an actuating element for unlocking the power supply unit, in which by pulling on the actuating element perpendicularly to the receiving direction, the power supply unit is released.

In a further embodiment, the electrical device is provided with an actuating element for unlocking the power supply unit, and the actuating element is movable in the receiving direction relative to the receiving region. As a result, handy and intuitive unlocking for a user can be attained.

Expediently, the locking device is provided for unlocking the power supply unit by means of a pressure in the receiving direction, exerted on the power supply unit and setting the entire power supply unit in motion relative to the receiving region. As a result, a separate actuating element can be dispensed with.

It is also proposed that the locking device has a leaf spring, which includes a detent structured feature. As a result, favorable, sturdy components can be used.

In this connection, the electrical device, in a further variant embodiment, is provided with an actuating element embodied as a slide element, in which the leaf spring, by a displacement of the slide element in a direction opposite the receiving direction, is deformed into a state that releases the power supply unit. As a result, an unlocking device that can be used intuitively by a user can be attained that moreover offers high security against unwanted unlocking of the power supply unit.

The electrical device can be made even more compact by providing that the power supply unit includes energy-storing units, and all the energy-storing units, in the locked state of the power supply unit, are located in the receiving region. This furthermore offers advantageous protection for the energy-storing units in the locked state.

### DRAWINGS

Further advantages will become apparent from the ensuing description of the drawings. In the drawings, exemplary embodiments of the invention are shown. The drawings, description and claims include numerous characteristics in combination. One skilled in the art will expediently consider the characteristics individually as well and put them together to make useful further combinations.

Shown are:

FIG. 1, a power tool with a removable power supply unit and with an actuating element;

FIG. 2, a view of the power supply unit of FIG. 1 from above;

FIG. 3, the power supply unit of FIG. 1 in a side view;

FIG. 4, a view of the actuating element of FIG. 1 from above;

FIG. 5, an alternative power supply unit and an alternative actuating element;

FIG. 6, a further power supply unit, with a detent structured feature in a side face, and a further actuating element;

FIG. 7, the power tool with the power supply unit of FIG. 5 and with a further actuating element;

FIG. 8, a view of the power supply unit and actuating element of FIG. 7 from above;

FIG. 9, a further actuating element;

FIG. 10, two detent elements;

FIG. 11, the detent elements of FIG. 10, with an actuating element;

FIG. 12, an alternative power supply unit with detent means and springs snapped into the detent means;

FIG. 13, the springs of FIG. 12 and an actuating element;

FIG. 14, a view of the actuating element of FIG. 13 from above;

FIG. 15, the power tool with the power supply unit of FIG. 12;

FIG. 16, an alternative power supply unit with a cushioned pin;

FIG. 17, a sliding block for guiding the pin of FIG. 16;

FIG. 18, the power tool with the power supply unit of FIG. 16;

FIG. 19, a slide pin in an alternative sliding block;

FIG. 20, an alternative power supply unit and a slide element;

FIG. 21, the power supply unit of FIG. 20 and an unlocking button; and

FIG. 22, the power supply unit of FIG. 20 and a lever.

### DESCRIPTION OF THE EXEMPLARY EMBODIMENTS

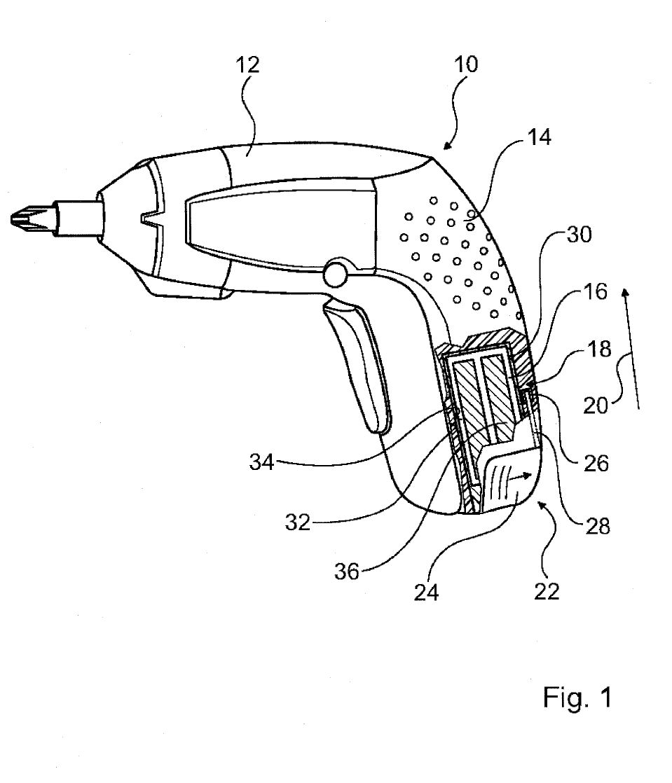

In FIG. 1, an electrical device is shown, embodied as a power tool 10. The power tool 10 has a motor housing 12 and a grip 14. In the grip 14, a receiving region 16 for receiving a removable power supply unit 18 in a receiving direction 20 is provided, as is a locking device 22, which serves to lock the power supply unit 18 in the receiving region 16. For actuating the locking device 22, the grip 14 is provided with an actuating element 24, which is held by a spring 28 secured to a suspension means 26. The power supply unit 18 includes a housing 30 with a side face 32 that rests on an inner face 34 of the grip 14. The housing 30 encloses energy-storing units 36, embodied as battery cells, which in the locked state of the power supply unit 18 are located inside the receiving region 16.

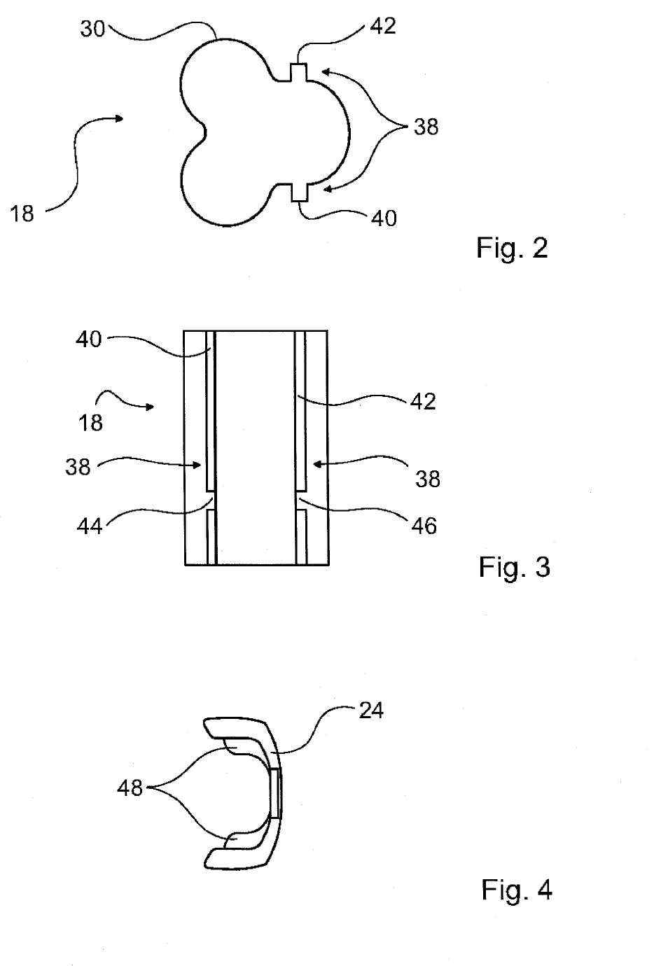

For guiding the power supply unit 18 in the receiving region 16, the power supply unit 18 is provided with a guide means 38, which has two guide strips 40, 42 shown in further detail in FIG. 2. These guide strips each engage a respective guide groove, not shown in the drawings, in the grip 14.

By means of the embodiment of the guide means 38 shown in FIG. 3, this guide means also serves to lock and unlock the power supply unit 18 in the receiving region 16. For that purpose, the guide strips 40, 42 each have an interruption, shown in FIG. 3, that forms a detent means 44 and 46, respectively, of the locking device 22. In these structured features of the guide means 38, in the locked state, a detent element 48 shown in FIG. 4 is snapped into place on both sides of the power supply unit 18. This detent element 48 is held by the actuating element 24 and is pressed by the spring 28 into the detent means 44, 46 embodied as interruptions. To unlock the power supply unit 18, a tensile force perpendicular to the receiving direction 20 is exerted by the user on the actuating element 24, causing the detent element 48 to be pulled out of the detent means 44, 46 embodied as interruptions and releasing the power supply unit 18.

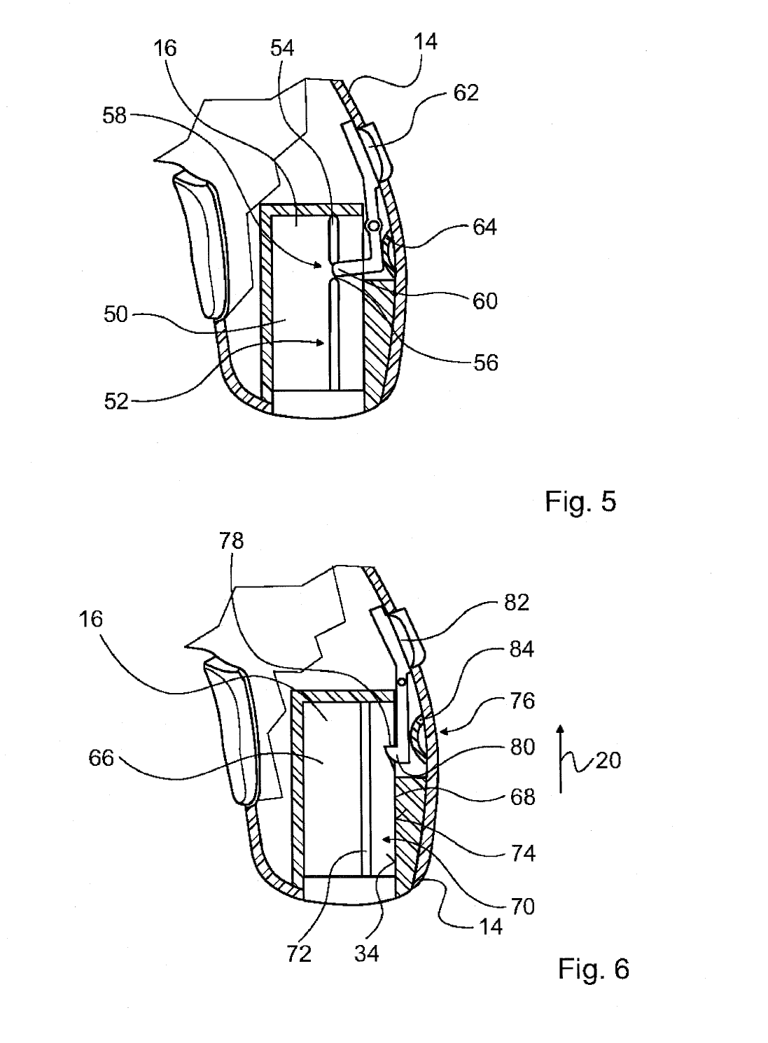

In FIG. 5, a further embodiment of a power supply unit 50 that is located in the receiving region 16 is shown. This power supply unit is designed similarly to the power supply unit 18 of FIG. 3 and includes a guide means 52 with a guide strip 54. The power supply unit 18 furthermore has a locking device 58 that includes a detent means 56; the detent means 56 is formed by an interruption in the guide strip 54. In the locked state, a detent element 60 that is formed integrally onto an actuating element 62 embodied as a lever is snapped into this detent means 56. The detent element 60 is pressed into the detent means 56 by a spring 64. Upon unlocking of the power supply unit 50, a pressure force is exerted on the actuating element 62, whereupon the power supply unit 60 is pulled out of the detent means 56, and the power supply unit 50 is released.

A further exemplary embodiment of a power supply unit 66 is shown in FIG. 6. It has a housing 68 and a guide means 70 that includes a guide strip 72. The housing 68 has a side face, which forms a further guide means 74 of the power supply unit 66. Upon introduction of the power supply unit 66 into the receiving region 16, the side face is oriented parallel to the receiving direction 20 and rests on the inner face 34 of the grip 14, and as a result the power supply unit 66 is guided in the receiving direction 20. For locking the power supply unit 66, this unit has a locking device 76, which includes a detent means 78 embodied as a structured feature of the guide means 74. In the locked state, a detent element 80 that is integrally formed onto an actuating element 82 embodied as a lever is snapped into this detent means 78. The detent element 80 is pressed into the detent means 78 by a spring 84.

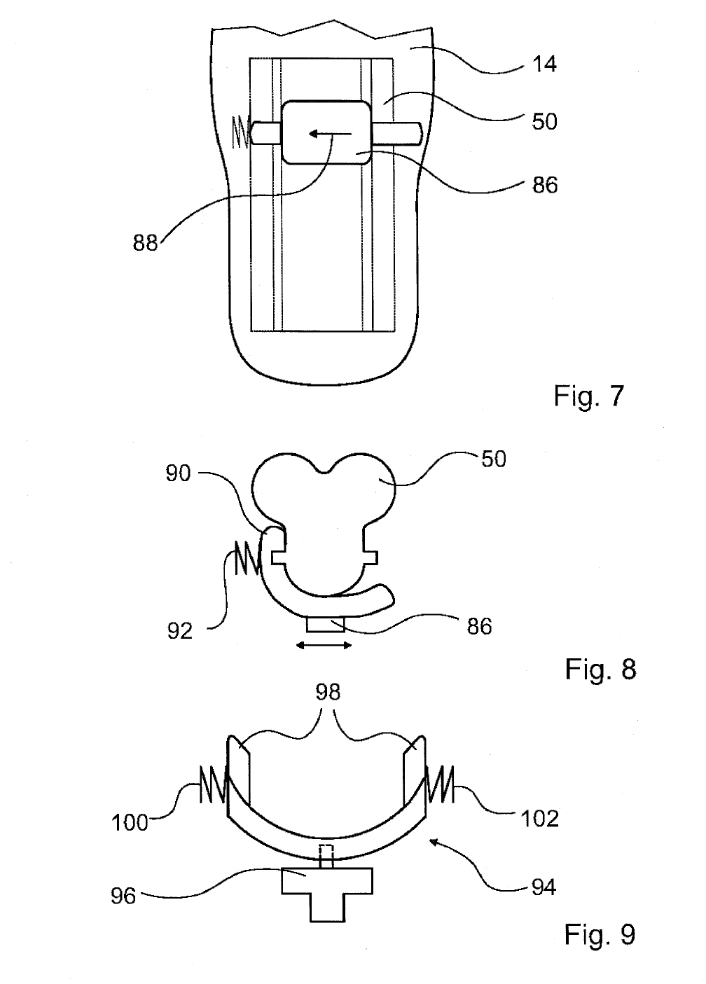

FIG. 7 shows the grip 14 of the power tool 10; the power supply unit 50 of FIG. 5 is located in this grip. The grip 14 is provided with an alternative actuating element 86, and sliding of this actuating element in a direction indicated by an arrow 88 releases the power supply unit 50 that has been locked in the receiving region 16. The disposition of the power supply unit 50 and of the actuating element 86 is shown from above in FIG. 8. The actuating element 86 has a detent element 90, embodied as a latch, which in the locked state is snapped into the detent means 56 of FIG. 5 embodied as an interruption, and is pressed into this detent means 56 by a spring 92.

FIG. 9 shows an alternative embodiment of an actuating element 94, with a pull button 96 and a detent element 98 which in the locked state is snapped into the detent means 56 of FIG. 5 and into a further detent means, not shown in FIG. 5, on either side of the power supply unit 50. Pulling on the pull button 96 perpendicularly to the receiving direction 20 makes it possible to release the power supply unit 50, located in the receiving region 16. Two springs 100, 102 serve to retract the detent element 98 back into the locking position.

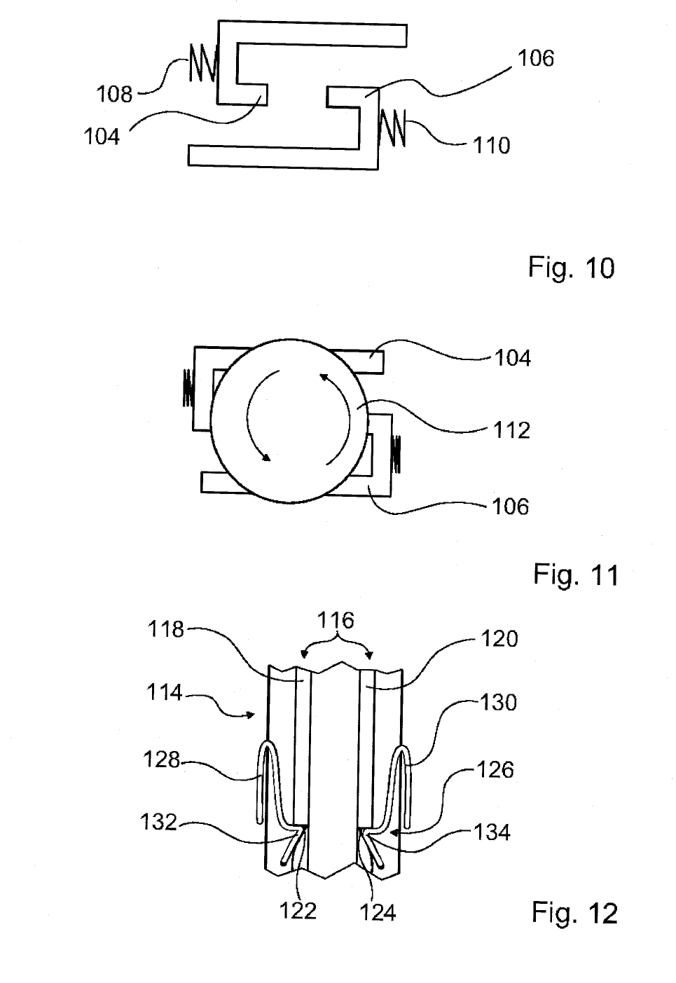

In FIG. 10, two detent elements 104, 106 are shown, which in the locked state of the power supply unit 50 of FIG. 5 are snapped into the detent means 56 and a further detent means, not shown in FIG. 5, on either side of the power supply unit 50 and are each pressed into these detent means by a respective spring 108 and 110. In FIG. 11, an actuating element 112 is shown; by rotating this actuating element 112, the detent elements 104, 106 are each displaced into a respective position, shown in FIG. 11, that releases the power supply unit 50.

A further embodiment of a power supply unit 114 is shown in FIG. 12. A guide means 116 with two guide strips 118, 120 can be seen. Each of these guide strips has a respective detent means 122 and 124, embodied as a structured feature, of a locking device 126, by means of which locking device the power supply unit 114 can be locked in the receiving region 16. The locking device 126 is furthermore provided with two spring elements 128, 130, which are fixed in the grip 14 and which each include a respective detent structured feature 132 and 134; the detent structured features 132 and 134 are each snapped into the respective detent means 122 and 124 in the locked state. The spring elements 128, 130 are each formed by a respective metal spring hook; the use of plastic hooks, placed for instance in the grip 14, is equally conceivable.

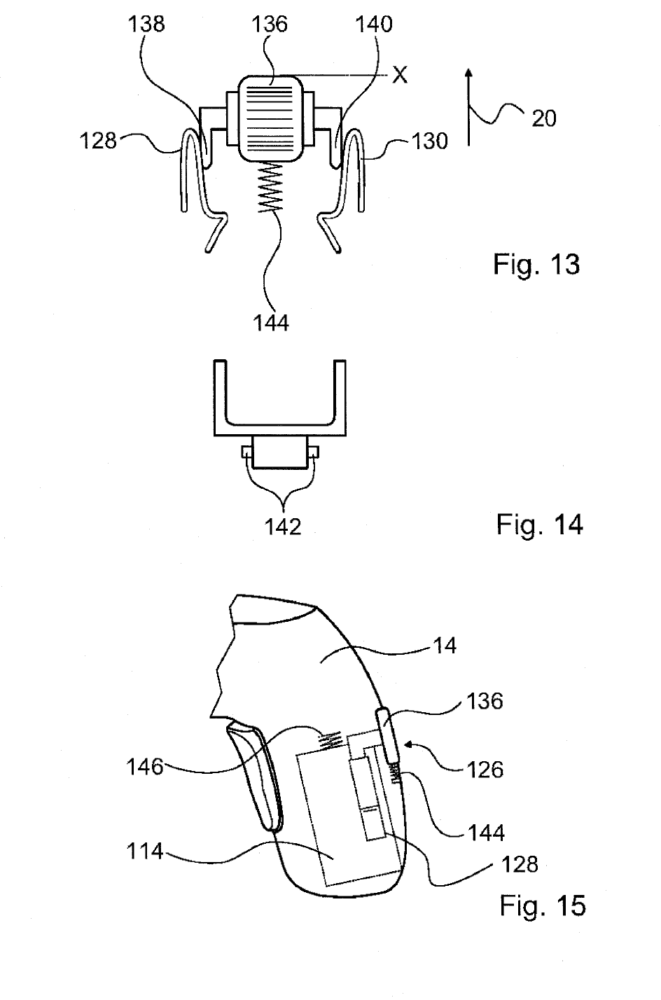

For unlocking the power supply unit 114, the grip 14 is provided with an actuating element 136, embodied as a slide, which is shown in FIG. 13. This element is movable in the receiving direction 20 relative to the receiving region 16, and sliding it in the direction opposite the receiving direction 20 makes it possible to release the power supply unit 114. In this sliding, by a pressing of ends 138, 140 of the actuating element 136, the spring elements 128, 130 are deformed until they are forced out of the detent means 122, 124. The sliding of the actuating element 136 from a starting position X is guided by guide elements 142, which can be seen in FIG. 14 and each engage respective guide grooves, not identified by reference numeral, in the grip 14. After unlocking of the power supply unit 114, the actuating element 136 is repositioned in the starting position X by a restoring spring 144.

In FIG. 15, the disposition of the power supply unit 114 and the locking device 126 in the grip 14 is shown. After being unlocked, sliding of the actuating element 136 causes the power supply unit 114 to be ejected from the receiving region 16 by an ejection spring 146.

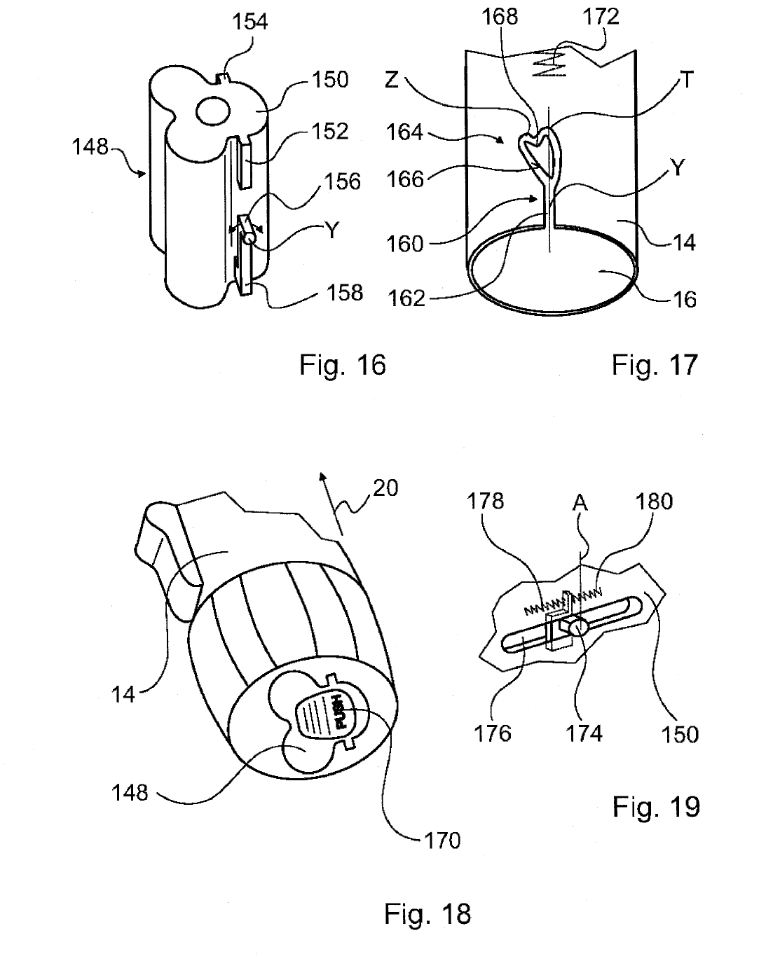

A further embodiment of a power supply unit 148 is shown in FIG. 16. It has a housing 150 with two guide strips 152, 154 and one cushioned pin 156, which is rotatable about a fixed point 158 in directions indicated by arrows. Upon a rotation from an untensed position Y, a spring not shown in the drawing is tensed, creating a restoring force.

In FIG. 17, a grip 14 belonging to the power supply unit 148 is shown. For guidance of the power supply unit 148 in the receiving region 16, the grip 14 is provided with a guide means 160, which includes a guide conduit 162. The grip 14 furthermore has a locking device 164, by means of which the power supply unit 148 can be locked in the receiving region 16. As the power supply unit 148 is introduced into the receiving region 16, the cushioned pin 156 engages the guide conduit 162 and is pressed by a face 166 of the guide conduit 162 out of the untensed position Y, represented by a dashed line, toward the left, as a result of which a restoring force is created. Once the cushioned pin 156 has reached a position Z and the power supply unit 148 has been let loose, the cushioned pin 156, as a result of the restoring force, snaps into a structured feature, embodied as a detent means 168 of the locking device 164, of the face 166, and the power supply unit 148 is locked. To unlock the power supply unit 148, a pressure force in the receiving direction 20 is exerted on a lower part 170 of the power supply unit 148, which part is visible to the user and is shown in FIG. 18. As a result, the entire power supply unit 148 is set into motion relative to the receiving region 16; the cushioned pin 156 is forced out of the detent means 168 by the sliding block and displaced by a distance until it is in a position T. When the user releases the power supply unit 148, this unit is ejected by an ejection spring 172, and the cushioned pin 156 is guided onward in the guide conduit 162 until it becomes disengaged from the guide conduit.

An alternative embodiment of a pin, embodied as a slide pin 174, is shown in FIG. 19. The slide pin 174 is located partly inside the housing 150 and is movable inside a guide conduit 176 in the housing 150. Upon a motion in this guide conduit 166 from a starting position A, a spring 178 or 180 is tensed or compressed, respectively, creating a restoring force. Upon introduction of the power supply unit 148, the guide conduit 176 is oriented perpendicular to the guide conduit 162 of the grip 14, which allows a motion of the slide pin 174 laterally to the receiving direction.

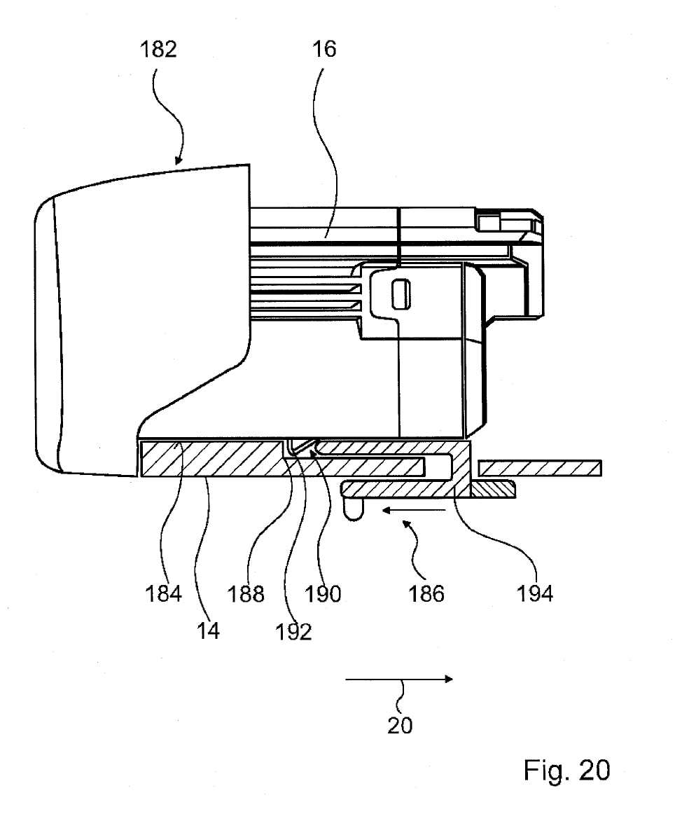

In FIG. 20, a further embodiment of the grip 14 is shown. A power supply unit 182 is located in the receiving region 16. An inner face of the grip 14 forms a guide means 184 for guiding the power supply unit 182 in the receiving region 16. The power supply unit 182 can be locked in the receiving region 16 by means of a locking device 186. For that purpose, the guide means 184 embodied as an inner face has a recess, which is formed as a detent means 188 of the locking device 186. The locking device 186 furthermore includes a leaf spring 190, which is fastened to the power supply unit 182 and has a detent structured feature 192, embodied as a detent lug; the detent structured feature 192 is snapped into the detent means 188 in the locked state. For unlocking the power supply unit 182, the grip 14 is provided with an actuating element 194, embodied as a slide element, which is movable in the receiving direction 20. By sliding of this slide element in the direction opposite the receiving direction 20, the leaf spring 190 is deformed into a state that releases the power supply unit 182.

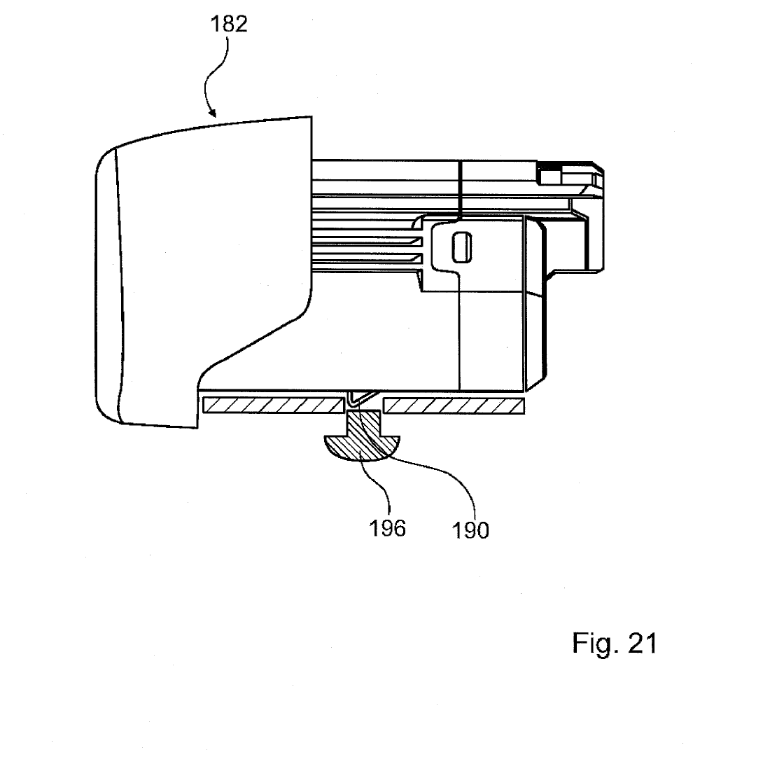

In FIG. 21, a further embodiment of an actuating element for unlocking the power supply unit is shown, in which the leaf spring 190 can be deformed by actuation of an unlocking button 196.

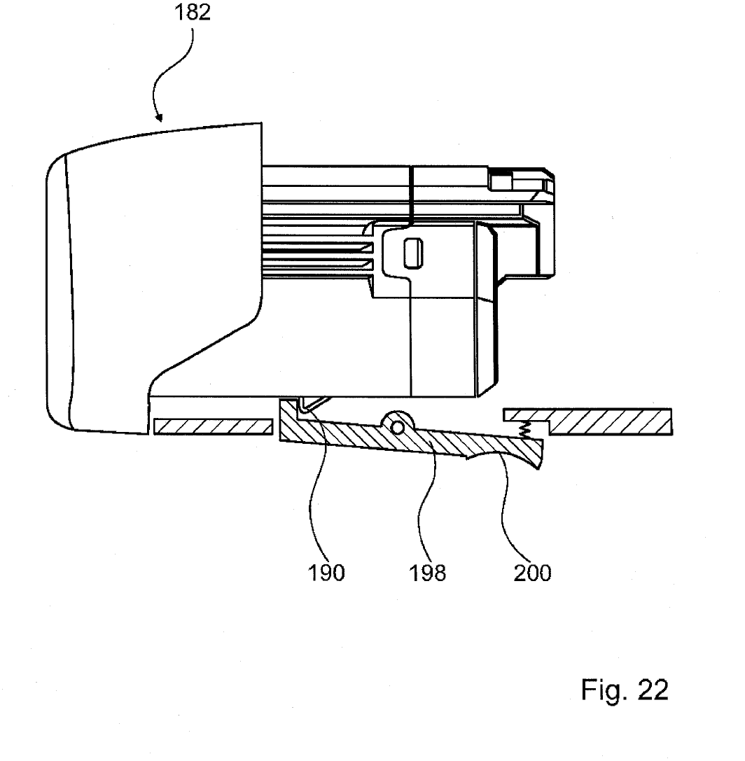

Alternatively, a further actuating element may be embodied as a lever 198, as shown in FIG. 22. Pressing on an end 200 of the lever 198 makes it possible to release the power supply unit 182.

1. An electrical device, in particular an electric power tool, having a removable power supply unit (18, 50, 66, 114, 148, 182), a receiving region (16) for receiving the power supply unit (18, 50, 66, 114, 148, 182) inserted in a receiving direction (20) into the receiving region (16), a guide means (38, 52, 74, 116, 160, 184) for guiding the power supply unit (18, 50, 66, 114, 148, 182) in the receiving region (16), and a locking device (22, 58, 76, 126, 164, 186) for locking the power supply unit (18, 50, 66, 114, 148, 182) in the receiving region (16), characterized in that the locking device (22, 58, 76, 126, 164, 186) has a detent means (44, 46, 56, 78, 122, 124, 166, 188), which is formed by a structured feature of the guide means (38, 52, 74, 116, 160, 184).

2. The electrical device as defined by claim 1, characterized in that the power supply unit (66) has a housing (68), with a side face that is embodied as a guide means (74).

3. The electrical device as defined by claim 1, characterized in that the guide means (38, 52, 116) has at least one guide strip (40, 42, 54, 118, 120), with an interruption embodied as detent means (44, 46, 56, 114, 182).

4. The electrical device as defined by claim 1, characterized by a detent element (48, 98), which in the locked state is snapped into structured features on both sides of the power supply unit (18, 50).

5. The electrical device as defined by claim 4, characterized in that the detent element (48) is retained by a cohesive actuating element (24).

6. The electrical device as defined by claim 1, characterized by an actuating element (24, 94) for unlocking the power supply unit (18, 50), in which by pulling on the actuating element (24, 94) perpendicularly to the receiving direction (20), the power supply unit (18, 50) is released.

7. The electrical device as defined by one of the claim 1, characterized by an actuating element (136, 194) for unlocking the power supply unit (114, 182), which element is movable in the receiving direction (20) relative to the receiving region (16).

8. The electrical device as defined by claim 1, characterized in that the locking device (164) is provided for unlocking the power supply unit (148) by means of a pressure in the receiving direction (20), exerted on the power supply unit (148) and setting the entire power supply unit (148) in motion relative to the receiving region (16).

9. The electrical device as defined by claim 1, characterized in that the locking device (186) has a leaf spring (190), which includes a detent structured feature (192).

10. The electrical device as defined by claim 9, characterized by an actuating element (194) embodied as a slide element, in which the leaf spring (190), by a displacement of the slide element in a direction opposite the receiving direction (20), is deformed into a state that releases the power supply unit (182).

11. The electrical device as defined by claim 1, characterized in that the power supply unit (18) includes energy-storing units (36), and all the energy-storing units (36), in the locked state of the power supply unit (18), are located in the receiving region (16).
